(19) United States
(12) Patent Application Publication
(10) Pub. No.: US 2015/0003486 A1
(43) Pub. Date: Jan. 1, 2015

(54) Laser Resonator Arrangement with Laser-Welded Optical Components

(71) Applicant: Trumpf Laser Marking Systems AG, Grusch (CH)

(72) Inventors: Dietmar Kruse, Malans (CH); Carsten Ziolek, Seewis-Dorf (CH); Stefan Marzenell, Malans (CH); Hagen Zimer, Jena (DE)

(21) Appl. No.: 14/490,971

(22) Filed: Sep. 19, 2014

Related U.S. Application Data
(63) Continuation of application No. PCT/EP2013/000735, filed on Mar. 13, 2013.

(30) Foreign Application Priority Data
Mar. 21, 2012 (EP) 12160606.5

(51) Int. Cl. H01S 3/02; C03B 23/20; H01S 3/08

(52) U.S. Cl. CPC H01S 3/025; H01S 3/08; C03B 23/20
USPC 372/92; 65/36

(57) ABSTRACT

A laser resonator arrangement includes multiple glass optical components, and a glass carrier plate, in which at least one of the optical components is secured to the carrier plate by at least one laser welding connection or is secured to the carrier plate through an intermediate glass element, in which the intermediate glass element is connected to both the at least one optical component and to the carrier plate by at least one laser welding connection.

### CROSS REFERENCE TO RELATED APPLICATIONS

This application is a continuation of and claims priority under 35 U.S.C. §120 to PCT Application No. PCT/EP2013/000735 filed on Mar. 13, 2013, which claimed priority to European Application No. 12 160 606.5, filed on Mar. 21, 2012. The contents of both of these priority applications are hereby incorporated by reference in their entirety.

### TECHNICAL FIELD

The present disclosure relates to a laser resonator arrangement with laser-welded optical components.

### BACKGROUND

U.S. Pat. No. 5,170,409 discloses a laser resonator arrangement in which the resonator mirror retention members of quartz glass are bonded to a planar carrier plate of glass or quartz glass using an ultraviolet (UV) adhesive. Since the carrier plate and the mirror retention members can be produced from materials with relatively low thermal expansion coefficients, the thermal stability of the laser resonator arrangement is improved.

In another known laser resonator arrangement, the surfaces of the optical components to be mounted are coated with metal and subsequently soldered by means of a soldering pad to a carrier plate which has corresponding metal counter-contacts. However, the metal-coating of the surfaces to be soldered involves high costs. Furthermore, in the case of different expansion coefficients of the optical component and carrier plate in the event of thermal loads, material stresses may occur which can lead to the misalignment of the optical components or even destroy the soldering connection.

When the adhesive has hardened or when the soldering pad solidifies, shrinkage effects occur which may lead to the misalignment of the optical components and allow automatic assembly only in a limited manner. Furthermore, with relatively high laser powers and small structural sizes, there is the risk of the adhesive or the soldering pad evaporating as a result of thermal loading and contaminating the resonator space. This may lead to unstable behavior of the laser resonator arrangement up to complete failure of the laser resonator.

In order to prevent deformation resulting from shrinkage effects, the thickness of the adhesive gap is intended to be minimized during adhesive bonding so that no wedge angle occurs. Ideally, the optical component and the carrier plate contact each other in a planar manner. Consequently, the number of degrees of freedom in which the optical component can be positioned relative to the carrier plate is limited to movements within the contact face. For example, from U.S. Pat. No. 6,320,706 and U.S. Patent Application Publication No. 2008/0260330, it is known that the use of appropriately formed auxiliary elements between an optical component and the carrier plate substantially eliminates this restriction and nonetheless allows a planar touching contact both with respect to the optical component and the carrier plate.

### SUMMARY

An object of the present disclosure is to provide a laser resonator arrangement and a corresponding assembly method, in which shrinkage effects, material stresses and evaporations are prevented such that the adjustment precision and the service-life of the optical components of the laser resonator are increased.

According to an aspect of the disclosure, the laser resonator arrangement includes multiple optical components and a carrier plate of glass, such as quartz glass, glass ceramic material or crystalline ceramic material, to which at least one of the optical components is secured. The at least one optical component that is secured to the carrier plate may be formed from glass, such as quartz glass, glass ceramic material or crystalline ceramic material, and may be either connected to the carrier plate in a firmly bonded manner directly by at least one laser welding connection or secured to the carrier plate by an intermediate element of glass, such as quartz glass, glass ceramic material or crystalline ceramic material. The intermediate element of glass may be connected both to the at least one optical component and to the carrier plate in a firmly bonded manner by at least one laser welding connection.

According to another aspect of the disclosure, one or more optical components of the laser resonator arrangement which is/are formed from glass, glass ceramic material or crystalline ceramic material is/are assembled on the carrier plate or the intermediate element (which is also formed from glass, glass ceramic material or crystalline ceramic material) by laser beam welding (also known as laser beam glass welding). The laser-welded optical components may, for example, include resonator mirrors, a solid-state laser medium, a lens (such as a gradient index lens for coupling pump light), and an optical modulator. All of the laser-welded optical components may be produced from glass or quartz glass or crystalline ceramic material (for example, BK7, Yb:glass, fused silica, SF57, ceramic material Nd:YAG). The carrier plate is preferably of a glass ceramic material, such as, for example, Zerodur or ULE.

In some implementations, all the optical components are formed from glass, such as quartz glass, glass ceramic material or crystalline ceramic material, and are connected to the carrier plate or intermediate elements in a firmly bonded manner by weld connections. Since all the optical components are laser-welded, neither solder nor adhesive is present in the laser resonator arrangement.

In some implementations, one or more of the optical components that are connected to the carrier plate in a firmly bonded manner are formed from materials with the same or substantially the same thermal expansion coefficients as the thermal expansion coefficient of the carrier plate. The similar expansion coefficients of the carrier plate and optical components result in almost stress-free firmly bonded connections, even with thermal loading. In some implementations, the optical components are formed from the same material as the carrier plate.

According to another aspect, the disclosure also relates to a method for producing laser resonator arrangements as described above, in which an optical component to be secured to the carrier plate is positioned on the carrier plate and, using a laser beam (such as a CO₂ laser beam), is subsequently either welded directly to the carrier plate in a firmly bonded manner or connected to the carrier plate by an intermediate element that is welded to the carrier plate in a firmly bonded manner.

The optical components are first individually positioned on the carrier plate and subsequently fixed by laser beam glass welding. The positioning of the optical components can be carried out passively by stops on the carrier plate or can alternatively be carried out using any of a variety of measuring methods (for example, camera-based methods, autocollimation, adjustment of a verification laser based on reflected laser beams from the verification laser, power maximization of the laser light) in a manually controlled manner or also in a partially or completely automated manner. A laser, such as a CO₂ laser, is moved by a suitable deflection device over the respective contours of the individual optical components where the optical components will be joined to the carrier plate. The laser provides the local energy input required for the glass welding. The information relating to the position of the contours where the components are joined can be established by the operator using appropriate measuring instruments and can be transmitted to the deflection device. Alternatively, appropriate measuring instruments, such as, for example, a camera system, can detect the required measurement data in a partially or fully automated manner and transmit them to the deflection device. When a CO₂ laser having a wavelength of 10.6 μm is used, the melt depth is typically only approximately 10 μm. When other lasers are used, the penetration depth of the laser radiation and consequently the melt depth can be optimized by the choice of glass that is used when the glass is doped with foreign atoms. The doping with foreign atoms increases the absorption of the laser radiation used for the laser beam welding. The melt depth is typically also dependent on the size of the components and the power of the laser used and should not be greater than approximately 500 μm and should preferably be between approximately 10 μm and approximately 30 μm.

For better heat discharge, it is possible to additionally contact-cool the solid-state laser medium on the carrier plate, which has poor heat conductivity, in order to efficiently discharge the heat that occurs during laser operation. The same applies to an active Q-switch, such as, for example, an acousto-optic modulator.

Advantages of the laser resonator arrangement according to the disclosure and the associated production method are summarized below:
The glass welding is more cost-effective than the soldering method, in which the optical units have to be surface-coated with metal.
The melt depth in glass welding is very low (from approximately 10 μm to approximately 30 μm). The laser-welded components are heated only in a very localized manner. Therefore, shrinkage is less important in comparison with soldering and adhesive-bonding methods.
The risk of gas emission, which may exist with soldering or adhesive-bonding connections depending on the solder/fluxing agent or adhesive used, is eliminated.
The welded firmly bonded connections are more insensitive with respect to misalignment than conventional mechanical retention members.
The production method is suitable for automation.
Adapted thermal expansion coefficients of the carrier plate and optical components lead to stress-free connections, even in the case of thermal loading.
A small thermal expansion coefficient of the carrier plate leads to a thermally stable structure.

Other advantages of the invention will be appreciated from the claims, the description and the drawings. The features mentioned above and those set out below may also be used individually per se or together in any combination. The embodiment shown and described is not intended to be understood to be a conclusive listing but is instead of exemplary character for describing the invention.

### BRIEF DESCRIPTION OF THE DRAWINGS

FIG. 1 is a schematic that illustrates a solid-state laser with a laser resonator arrangement.

FIG. 2 is a schematic that illustrates a laser welding connection between a carrier plate and an optical components.

FIG. 3 is a schematic that illustrates an optical component connected to a carrier plate by a laser-welded intermediate element.

### DETAILED DESCRIPTION

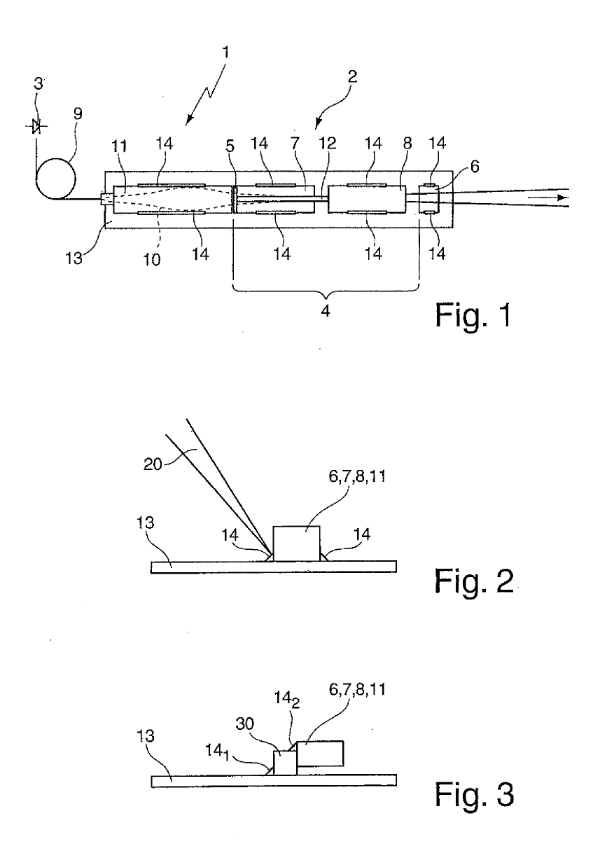

The solid-state laser 1 shown in FIG. 1 has a laser resonator arrangement 2 and a laser diode 3 for optically pumping the laser resonator arrangement 2. The laser resonator arrangement 2 includes a laser resonator 4 that is defined by a highly reflective (HR) end mirror 5 and a decoupling mirror 6, a solid-state laser medium 7 that is arranged in the laser resonator 4, and an optical modulator 8 that is arranged in the laser resonator 4 between the laser medium 7 and the decoupling mirror 6.

A laser diode of high brightness coupled by a fiber 9 is used as a laser diode 3. The high brightness enables high pumping power densities in the laser medium 7. In order to focus the pump light 10 (illustrated with broken lines) of the laser diode 3 in the laser medium 7, the fiber end of the fiber-coupled laser diode 3 is spliced on a gradient index lens (GRIN lens) 11 of quartz glass. Accordingly, the GRIN lens 11 has to be correctly positioned, but separate positioning and retention of the fiber end are not required.

The laser medium 7 may include, for example, Nd:glass, Er:glass or Yb:glass. The end face of the laser medium 7 that faces the GRIN lens 11 is provided with a dielectric coating. The dielectric coating is transmitting for the pump light 10 and highly reflective for the laser light 12, and consequently constitutes the HR end mirror 5. The decoupling mirror 6 is formed by a separate optical unit of quartz glass which has, at the end side facing the laser medium 7, a dielectric coating that is partially reflective for the laser light 12 and consequently constitutes the decoupling mirror 6.

The optical modulator 8 is constructed as an active Q-switch, such as, for example, an acousto-optic modulator or as an electro-optic modulator, or as a passive Q-switch.

In the implementation shown, the optical components of the laser resonator arrangement 2, i.e., the decoupling mirror 6, the laser medium 7 having the HR end mirror 5 provided thereon, the Q switch 8 and also the GRIN lens 11, are assembled in each case by weld connections 14 in a firmly bonded manner on a carrier plate 13 of glass ceramic material. The carrier plate 13 may include glass ceramic materials such as, for example, Zerodur or Ultra Low Expansion (ULE) titanium silicate glass. Both material groups are distinguished by very low thermal expansion coefficients, whereby the laser resonator arrangement 2 can be constructed in a very temperature-stable manner. Each optical component 6, 7, 8, 11 is secured to the carrier plate 13 by at least one laser weld seam, preferably two laser weld seams 14.

In order to form the laser weld seams 14, the decoupling mirror 6, the laser medium 7 having the HR end mirror 5 provided thereon, the Q-switch 8 and the GRIN lens 11 are positioned on the carrier plate 13. Then, as shown in FIG. 2, each of the decoupling mirror 6, the laser medium 7 having the HR end mirror 5 provided thereon, the Q-switch 9 and the GRIN lens 11 is welded to the carrier plate 13 at the two longitudinal edges thereof by a laser 20 such as, for example, a CO₂ laser. The melt depth of the laser weld seams 14 in the carrier plate 13 and in the optical components 6, 7, 8, 11 that are connected thereto in a firmly bonded manner is in this example only from approximately 10 μm to approximately 30 μm.

In FIG. 3, the optical components 6, 7, 8, 11 are secured to the carrier plate 13 by an intermediate element 30 of glass, such as quartz glass, glass ceramic material or crystalline ceramic material. The intermediate element 430 is connected in a firmly bonded manner by a laser weld connection 141, 142 to both the optical components 6, 7, 8, 11 and to the carrier plate 13.

A number of embodiments have been described. Nevertheless, it will be understood that various modifications may be made without departing from the spirit and scope of the invention. Accordingly, other embodiments are within the scope of the following claims.

What is claimed is:

1-13. (canceled)

14. A laser resonator arrangement comprising:
a plurality of glass optical components; and
a glass carrier plate,
wherein at least one of the optical components is secured to the carrier plate by at least one laser welding connection or is secured to the carrier plate through an intermediate glass element, the intermediate glass element being connected to both the at least one optical component and the carrier plate by at least one laser welding connection.

15. The laser resonator arrangement of claim 14 wherein the at least one optical component comprises a resonator mirror.

16. The laser resonator arrangement of claim 14, wherein the at least one optical component comprises a solid-state laser medium.

17. The laser resonator arrangement of claim 14, wherein the at least one optical component comprises an optical modulator.

18. The laser resonator arrangement of claim 14, wherein the at least one optical component comprises an optical coupling unit arranged to couple pump light from a light source to the laser resonator arrangement.

19. The laser resonator arrangement of claim 18, wherein the at least one optical component is a gradient index lens.

20. The laser resonator arrangement of claim 14, wherein each of the optical components is formed of glass and is connected to the carrier plate or to an intermediate element by a corresponding laser weld connection.

21. The laser resonator arrangement of claim 14, wherein each optical component that is connected to the carrier plate or to the intermediate element is formed of a material with the same or substantially the same thermal expansion coefficient as either the thermal expansion coefficient of the carrier plate to which the optical component is connected or the thermal expansion coefficient of the intermediate element to which the optical component is connected.

22. The laser resonator arrangement of claim 14, wherein the laser welding connection comprises at least one laser weld seam that extends along a contour of the at least one optical component where the optical component joins the carrier plate or the intermediate element.

23. The laser resonator arrangement of claim 14, wherein a maximum melt depth of the laser weld connection in the carrier plate and in the at least one optical component is approximately 500 μm.

24. The laser resonator arrangement of claim 23, wherein the melt depth of the laser weld connection in the carrier plate and in the at least one optical component is between approximately 10 μm and approximately 30 μm.

25. The laser resonator arrangement of claim 14, wherein the at least one of the optical component is in thermal contact with at least one additional surface for cooling the at least one optical component.

26. The laser resonator arrangement of claim 14, wherein the glass carrier plate is formed of quartz glass, a glass ceramic material, or a crystalline ceramic material.

27. The laser resonator arrangement of claim 14, wherein the at least one optical component is formed of quartz glass, a glass ceramic material, or a crystalline ceramic material.

28. The laser resonator arrangement of claim 14, wherein the intermediate element is formed of quartz glass, a glass ceramic material, or a crystalline ceramic material.

29. The laser resonator arrangement of claim 1, wherein at least one of the glass carrier plate, the intermediate glass element or the glass optical components has been doped with foreign atoms to provide an optimized laser melt depth between approximately 10 μm and approximately 30 μm for the laser welding connection.

30. A method for producing a laser resonator arrangement, the method comprising:
positioning a glass optical component on a glass carrier plate or on an intermediate glass element between the glass optical component and the glass carrier plate; and
laser-welding the glass optical component directly to the glass carrier plate or laser-welding the glass optical component directly to the intermediate glass element and the intermediate glass element to the glass carrier plate.

31. The method of claim 30, wherein laser-welding comprises irradiating along the edge of a contour of the glass optical component between the glass optical component and the glass carrier plate or between the glass optical component and the intermediate glass element.

32. The method of claim 30, wherein laser-welding comprises irradiating the glass optical component with a CO₂ laser beam.
